(19) United States
(12) Patent Application Publication
(10) Pub. No.: US 2026/0042341 A1
(43) Pub. Date: Feb. 12, 2026

(54) Mount Connecting Structure for a Motorcycle Engine

(71) Applicants: Miaoshun Lin, Taizhou City, Zhejiang Province (CN); Huajun Jiang, Taizhou City, Zhejiang Province (CN); Jian Zhang, Taizhou City, Zhejiang Province (CN); Weijian Zheng, Taizhou City, Zhejiang Province (CN); Yifei Huang

(72) Inventors: Miaoshun Lin, Taizhou City, Zhejiang Province (CN); Huajun Jiang, Taizhou City, Zhejiang Province (CN); Jian Zhang, Taizhou City, Zhejiang Province (CN); Weijian Zheng, Taizhou City, Zhejiang Province (CN); Yifei Huang

(73) Assignee: Zhejiang Qianjiang Motorcycle Co., Ltd., Taizhou City, Zhejiang Province (CN)

(21) Appl. No.: 18/998,466

(22) PCT Filed: Jul. 4, 2023
(86) PCT No.: PCT/CN2023/105631

§ 371 Date: Jan. 25, 2025

(30) Foreign Application Priority Data
Aug. 2, 2022 (CN) 202210923153.8

(51) Int. Cl. B60K 5/12; B62K 11/04; B62M 7/02; F16F 15/08

(52) U.S. Cl. CPC B60K 5/1225; B62K 11/04; B62M 7/02; F16F 15/08

(57) ABSTRACT

The present disclosure provides a mount connecting structure for a motorcycle engine, and belongs to the technical field of motorcycles. The mount connecting structure for a motorcycle engine includes a fixed arm located on a frame, a buffer rubber wheel, a buffer connecting arm, a supporting arm and a connecting rod, the buffer rubber wheel sleeves a periphery of the connecting rod and is embedded in an end portion of the fixed arm, the engine is connected to the connecting rod, one end of the buffer connecting arm is hinged to the connecting rod, the connecting rod is arranged transversely, one end of the supporting arm is hinged to the fixed arm, the other end of the buffer connecting arm is hinged to the other end of the supporting arm, and the supporting arm is obliquely arranged downwards to form an included angle relative to the buffer connecting arm.

### TECHNICAL FIELD

The disclosure belongs to the technical field of motorcycles, and relates to a mount connecting structure for a motorcycle engine.

### BACKGROUND

A mount for a motorcycle engine functions as a supporting and vibration-isolating member that connects the engine and a frame, and is able to isolate vibration transmission of the engine and significantly improve comfort of a whole motorcycle.

For example, a patent document with Publication number CN1530280A disclosed a small motorcycle. A front portion of a unit swing type power unit is supported on a frame to swing the power unit. The motorcycle includes: a pivot supported on a frame side by means of a shaft, a pair of left and right motorcycle body side shafts supported on the frame side by means of shafts, an engine side shaft supported on an engine side of the unit swing type power unit through a bearing member capable of freely rotating, a compression rod connecting the pivot and the engine side shaft in a swingable manner, and an engine side suspension link connecting the motorcycle body side shafts and the engine side shaft. One end of the engine side suspension link is supported on the motorcycle body side shafts by means of the shafts through a motorcycle body side rubber sleeve having elasticity in a torsion direction of the shafts, the other end of the engine side suspension link is supported on the engine side shaft by means of the shaft through an engine side rubber sleeve having elasticity, and the engine side rubber sleeve has a spring characteristic of being flexible in a direction of a connecting line L2 connecting the motorcycle body side shafts and the engine side shaft and being hard in a direction orthogonal to the connecting line L2.

The above structure will achieve a vibration reduction effect to some extent, but a vibration load of an engine of the structure is concentrated at a hinge portion of the power unit, resulting in a weak bearing capability, and posing a hidden danger of influencing stabilization of the vibration buffering effect.

### SUMMARY

Aiming at the above problem existing in the prior art, the disclosure provides a mount connecting structure for a motorcycle engine. The technical problem to be solved by the disclosure is how to ensure stabilization of a vibration buffering effect of an engine.

An objective of the disclosure can be achieved by the following technical solution:

a mount connecting structure for a motorcycle engine includes a fixed arm located on a frame and a buffer rubber wheel, where the mount connecting structure further includes a buffer connecting arm, a supporting arm and a connecting rod, where the buffer rubber wheel sleeves a periphery of the connecting rod and is embedded in an end portion of the fixed arm, the engine is connected to the connecting rod, one end of the buffer connecting arm is hinged to the connecting rod, the connecting rod is arranged transversely, one end of the supporting arm is hinged to the fixed arm, the other end of the buffer connecting arm is hinged to the other end of the supporting arm, and the supporting arm is obliquely arranged downwards to form an included angle relative to the buffer connecting arm.

The engine is a power source for motorcycle riding, the fixed arm can be fixedly connected to the frame to maintain a stable position, and the buffer rubber wheel can deform under force to absorb vibration during operation and vibration of the whole engine, so as to avoid rigid collision. By means of arrangement, one end of the supporting arm is hinged to the fixed arm, and one end of the buffer connecting arm is hinged around the connecting rod. Moreover, the engine is connected to the connecting rod, the buffer rubber wheel embedded in the fixed arm sleeves the periphery of the connecting rod arranged transversely, and the buffer connecting arm and the supporting arm obliquely arranged downwards are hinged in a crossed manner. When the engine vibrates in a longitudinal direction or/and a vertical direction, a vibration load can be transmitted to the fixed arm by means of the supporting arm and the buffer connecting arm which are hinged. Thus, the load of the engine is mainly borne by the fixed arm. The connecting rod can be still freely changed in the vertical direction and the longitudinal direction in a constraint range of the buffer rubber wheel according to an actual vibration condition in a vibration process of the engine by means of arrangement of the supporting arm and the buffer connecting arm. Moreover, a transverse load and a torque load are borne by the supporting arm and the buffer connecting arm, such that a vibration mode of the engine is limited in the vertical direction and the longitudinal direction, and the transverse load and the torque load borne by the buffer rubber wheel are reduced. Thus, an influence on structural stability caused by transverse vibration of the engine relative to the frame and a resisting effect of the engine on a vibration buffering component caused by excessively large torsion is avoided.

In the above mount connecting structure for a motorcycle engine, two buffer rubber wheels are provided and are symmetrically arranged on two transverse sides of the engine. Thus, when the torque load is borne, the two buffer rubber wheels can deform from two transverse sides to form a more stable vibration buffering effect on the engine.

In the above mount connecting structure for a motorcycle engine, the buffer connecting arm has a length dimension greater than a length dimension of the supporting arm. The length dimension of the buffer connecting arm is a distance from a hinge center of the buffer connecting arm and the connecting rod to a hinge center of the buffer connecting arm and the supporting arm, and the length dimension of the supporting arm is a distance from the hinge center of the supporting arm and the buffer connecting arm to a hinge center of the supporting arm and the fixed arm. Since the length dimension of the buffer connecting arm is greater than the length dimension of the supporting arm, the length dimension of the buffer connecting arm directly dragged by the engine is set to be larger, such that a relative rotation angle between the buffer connecting arm and the supporting arm caused when vibration of the engine is transmitted to a hinge end of the buffer connecting arm and the supporting arm is low. Thus, structural wear of a hinge portion of the buffer connecting arm and the supporting arm is reduced, and stabilization of a vibration buffering effect is ensured.

In the above mount connecting structure for a motorcycle engine, a damping bushing arranged transversely and capable of increasing a relative swing resistance of the buffer connecting arm and the supporting arm is arranged between the buffer connecting arm and the supporting arm, and a damping bushing arranged transversely and capable of increasing a swing resistance of the supporting arm relative to the fixed arm is arranged between the supporting arm and the fixed arm. Thus, the damping bushing can strengthen the vibration buffering effect by consuming vibration energy of the engine under the condition that a vibration direction of the engine is constrained.

In the above mount connecting structure for a motorcycle engine, the two buffer rubber wheels are arranged at two transverse ends of the connecting rod respectively. Thus, a distance between the two buffer rubber wheels is large, such that deformation required by the buffer rubber wheels when the torque load caused by the vibration of the engine is overcome is small. Thus, stability of constraint in the vibration direction of the engine is ensured.

In the above mount connecting structure for a motorcycle engine, the supporting arm includes two rod bodies arranged transversely and two connecting plates spaced transversely, where the two connecting plates and the two rod bodies define a frame shape, and the two rod bodies match the fixed arm and the buffer connecting arm in a hinged manner respectively. Thus, a structure of the whole supporting arm has an optimal torque resistance effect, such that a guiding effect and the vibration buffering effect are more stable.

In the above mount connecting structure for a motorcycle engine, an end portion of the buffer connecting arm is provided with a pipe body arranged transversely, the pipe body sleeves a periphery of the rod body, and the damping bushing between the buffer connecting arm and the supporting arm is arranged between the rod body and the pipe body. Thus, a contact length of the hinge portion of the buffer connecting arm and the supporting arm can be increased. Thus, the torque resistance effect is improved.

In the above mount connecting structure for a motorcycle engine, the other end of the buffer connecting arm is provided with a pipe sleeve sleeving a periphery of the connecting rod, and the engine is hinged to the pipe sleeve. Thus, the load borne at the portion can be shared by the pipe sleeve sleeving the periphery of the connecting rod bearing the load in a concentrated manner, so as to form protection for the connecting rod. Thus, centralized scraping on the connecting rod is avoided, and the structural stability is improved.

In the above mount connecting structure for a motorcycle engine, the engine is provided with at least two connecting legs spaced transversely, a peripheral surface of the pipe sleeve is provided with two limiting stop shoulders, the two limiting stop shoulders are located between the two connecting legs, and the two limiting stop shoulders abut against the two connecting legs in a limiting manner respectively. Thus, the engine and the buffer connecting arm are fixedly connected in a limiting manner in an axial direction of the pipe sleeve. Thus, a constraint effect on the vibration direction of the engine is strengthened.

In the above mount connecting structure for a motorcycle engine, the included angle between the buffer connecting arm and the supporting arm ranges from 70 degrees to 110 degrees. Thus, directly driving the buffer connecting arm to swing or driving the supporting arm to swing by means of the buffer connecting arm can be maintained in a labor-saving torque range, such that the vibration mode of the engine can be more easily limited in longitudinal vibration and vertical vibration driving the buffer connecting arm and the supporting arm to swing. Thus, the vibration buffering effect is ensured.

Compared with the prior art, the disclosure has the advantages as follows:

in the mount connecting structure for a motorcycle engine, the load of the engine is mainly borne by the fixed arm, and the connecting rod can be still freely changed in the vertical direction and the longitudinal direction in the constraint range of the buffer rubber wheel according to an actual vibration condition in the vibration process of the engine by means of the arrangement of the supporting arm and the buffer connecting arm. Moreover, the transverse load and the torque load are borne by the supporting arm and the buffer connecting arm, such that the vibration mode of the engine is limited in the vertical direction and the longitudinal direction, and the transverse load and the torque load borne by the buffer rubber wheel are reduced. Thus, the influence on the structural stability caused by the transverse vibration of the engine relative to the frame and the resisting effect of the engine on the vibration buffering component caused by the excessively large torsion is avoided.

### BRIEF DESCRIPTION OF THE DRAWINGS

FIG. 1 is a schematic diagram of a local perspective structure of one embodiment.

FIG. 2 is a schematic diagram of a local perspective structure of a rear portion structure of an arm body on one side of a hidden fixed arm of one embodiment.

FIG. 3 is a schematic diagram of a side structure of the rear portion structure of the arm body on one side of the hidden fixed arm of one embodiment.

FIG. 4 is a schematic diagram of a perspective structure of a supporting arm and damping bushings in one embodiment.

FIG. 5 is a schematic diagram of a perspective structure of a buffer connecting arm in one embodiment.

FIG. 6 is a schematic diagram of a perspective structure of a fixed arm and damping bushings in one embodiment.

FIG. 7 is a schematic diagram of a perspective structure of a buffer rubber wheel in one embodiment.

In the drawings, 1, engine; 11, connecting leg;
2, fixed arm; 2a, arm body; 2a1, mounting hole; 2b, transverse rod; 3, buffer rubber wheel;
4, buffer connecting arm; 41, pipe sleeve; 42, limiting stop shoulder; 43, pipe body;
5, supporting arm; 51, rod body; 52, connecting plate;
6, connecting rod; and 7, damping bushing.

### DETAILED DESCRIPTION

The technical solution of the disclosure will be further described below by means of the particular embodiments and in combination with the accompanying drawings, but the disclosure is not limited to these embodiments.

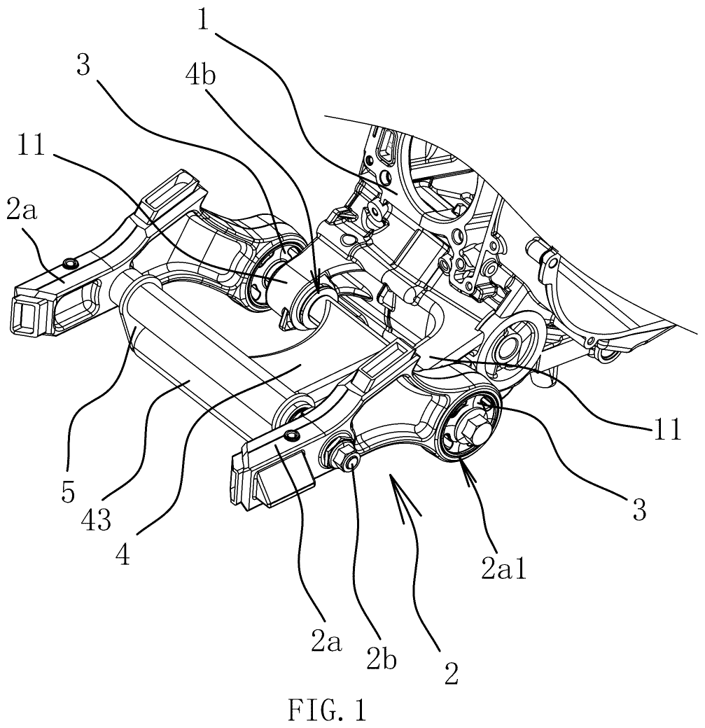

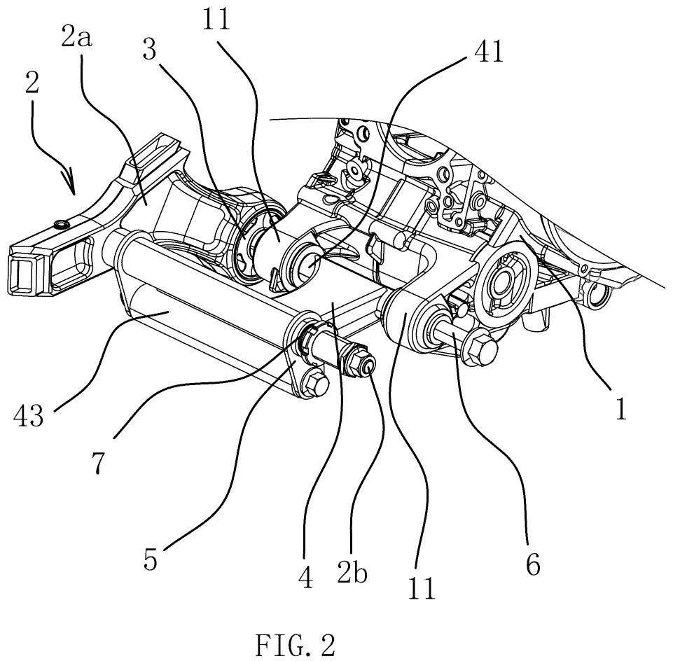

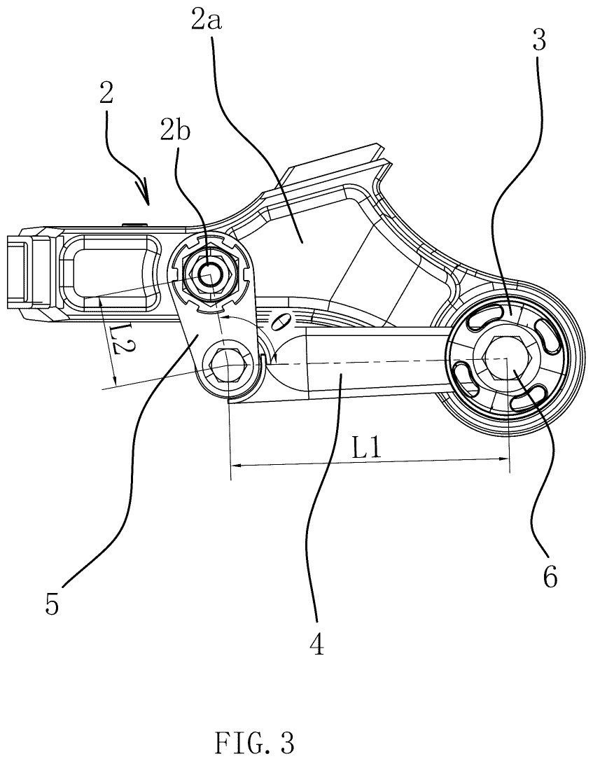

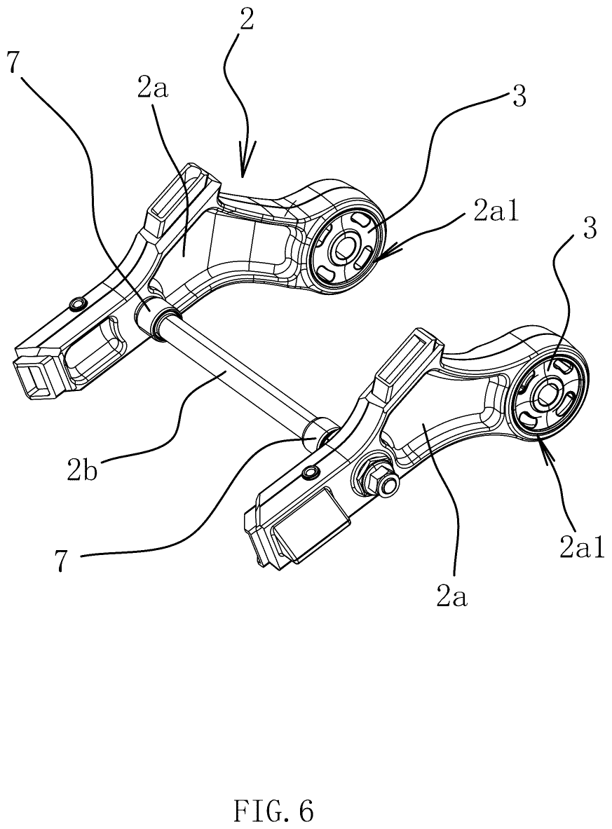

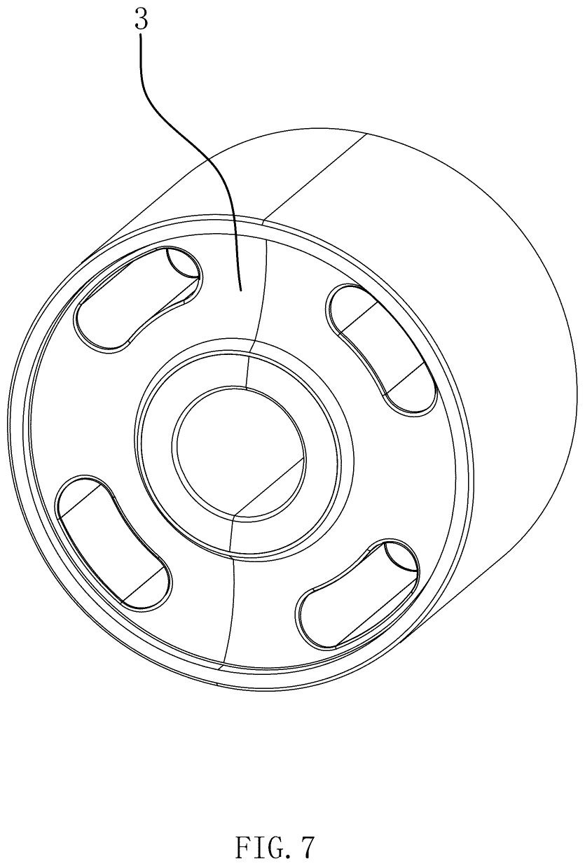

As shown in FIG. 1, a mount connecting structure of a motorcycle engine includes a fixed arm 2 located on a frame (not shown in the drawings) and buffer rubber wheels 3. The fixed arm 2 includes arm bodies 2a arranged in a longitudinal direction. The two arm bodies 2a are provided and are arranged in a transverse direction, and the buffer rubber wheel 3 is fixed on a rear end of each arm body 2a. The buffer rubber wheels 3 have elasticity and are existing components. In combination with FIG. 6 and FIG. 7, a mounting hole 2a1 is provided on the rear end of the arm body 2a, and the buffer rubber wheel 3 is embedded in and fixed in the mounting hole 2a1. In combination with FIG. 2 and FIG. 3, the mount connecting structure further includes a buffer connecting arm 4, a supporting arm 5 and a connecting rod 6 arranged transversely. The buffer rubber wheels 3 sleeves a periphery of the connecting rod 6 and are embedded in an end portion of the fixed arm 2, the supporting arm 5 is obliquely arranged downwards, the buffer connecting arm 4 and the supporting arm 5 are arranged in a crossed manner, and end portions of the buffer connecting arm and the supporting arm are hinged. As shown in FIG. 6, the fixed arm 2 further includes a transverse rod 2b located in a middle section of the fixed arm 2 and arranged transversely. One end of the supporting arm 5 is hinged to the transverse rod 2b, one end of the buffer connecting arm 4 and the engine 1 are both hinged to the connecting rod 6 and may swing around a circumferential direction of the connecting rod 6, the other end of the buffer connecting arm 4 is hinged to the other end of the supporting arm 5, and the supporting arm 5 is obliquely arranged downwards to form an included angle relative to the buffer connecting arm 4. The supporting arm 5 and the buffer connecting arm 4 are both located between the two arm bodies 2a of the fixed arm 2, two ends of the transverse rod 2b are inserted into and fixed to middle sections of the two arm bodies 2a respectively, and two ends of the connecting rod 6 are inserted into and fixed to the corresponding buffer rubber wheels 3 respectively. The engine 1 is a power source for motorcycle riding, the fixed arm 2 can be fixedly connected to the frame to maintain a stable position, and the buffer rubber wheels 3 can deform under force to absorb vibration during operation and vibration of the whole engine 1, so as to avoid rigid collision. By arranging the buffer connecting arm 4 and the supporting arm 5 to be hinged in a crossed manner, one end of the supporting arm 5 is hinged to the fixed arm 2, and one end of the buffer connecting arm 4 and the engine 1 are both hinged around the connecting rod 6. The buffer rubber wheels 3 embedded in the fixed arm 2 sleeve the periphery of the connecting rod 6 arranged transversely. Thus, a load of the engine 1 is mainly borne by the fixed arm 2. The connecting rod 6 can be still freely changed in the vertical direction and the longitudinal direction in a constraint range of the buffer rubber wheels 3 according to an actual vibration condition in a vibration process of the engine 1 by means of arrangement of the supporting arm 5 and the buffer connecting arm 4. Moreover, a transverse load and a torque load are borne by the supporting arm 5 and the buffer connecting arm 4, such that a vibration mode of the engine 1 is limited in the vertical direction and the longitudinal direction, and the transverse load and the torque load borne by the buffer rubber wheels 3 are reduced. Thus, an influence on structural stability caused by transverse vibration of the engine 1 relative to the frame and a resisting effect of the engine 1 on a vibration buffering component caused by excessively large torsion is avoided.

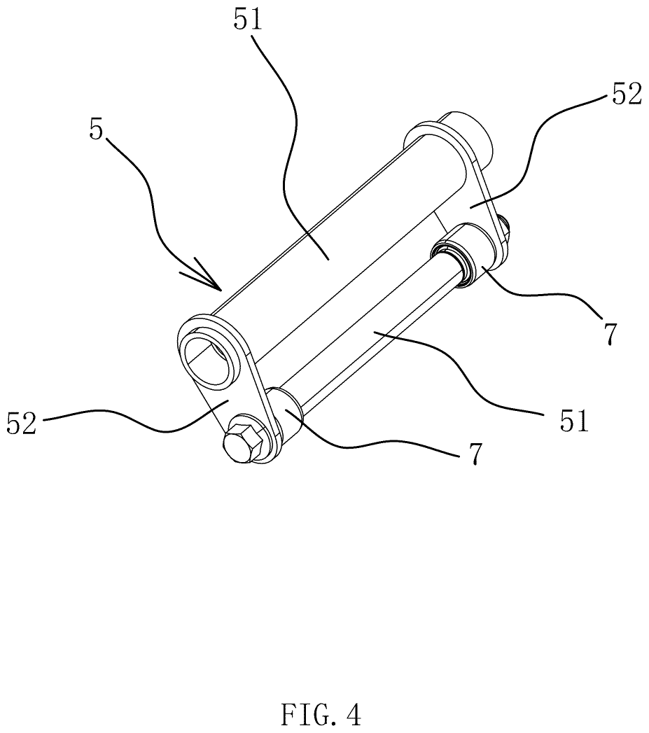

As shown in FIGS. 1-3, specifically, two buffer rubber wheels 3 are provided and are symmetrically arranged on two transverse sides of the engine 1. Thus, when the torque load is borne, the two buffer rubber wheels 3 can deform from two transverse sides to form a more stable vibration buffering effect on the engine 1. Preferably, the two buffer rubber wheels 3 are arranged at two transverse ends of the connecting rod 6 respectively. Thus, a distance between the two buffer rubber wheels 3 is large, such that deformation required by the buffer rubber wheels 3 when the torque load caused by the vibration of the engine 1 is overcome is small. Thus, stability of constraint in the vibration direction of the engine 1 is ensured. The buffer connecting arm 4 has a length dimension greater than a length dimension of the supporting arm 5. As shown in FIG. 3, the length dimension of the buffer connecting arm 4 is a distance from a hinge center of the buffer connecting arm 4 and the connecting rod 6 to a hinge center of the buffer connecting arm 4 and the supporting arm 5, which is marked as L1 in the drawing; and the length dimension of the supporting arm 5 is a distance from the hinge center of the supporting arm 5 and the buffer connecting arm 4 to a hinge center of the supporting arm 5 and the fixed arm 2, which is marked as L2 in the drawing. Thus, the length dimension of the buffer connecting arm 4 directly dragged by the engine 1 is set to be larger, such that a relative rotation angle between the buffer connecting arm 4 and the supporting arm 5 caused when vibration of the engine 1 is transmitted to a hinge end of the buffer connecting arm 4 and the supporting arm 5 is low. Thus, structural wear of a hinge portion of the buffer connecting arm 4 and the supporting arm 5 is reduced, and stabilization of a vibration buffering effect is ensured. As shown in FIG. 3, an included angle between the buffer connecting arm 4 and the supporting arm 5 is marked as θ. In an initial state, the included angle θ between the buffer connecting arm 4 and the supporting arm 5 is 100 degrees, and the included angle θ between the buffer connecting arm 4 and the supporting arm 5 may be changed in a range of 70 degrees to 110 degrees. Thus, directly driving the buffer connecting arm 4 to swing or driving the supporting arm 5 to swing by means of the buffer connecting arm 4 can be maintained in a labor-saving torque range, such that the vibration mode of the engine 1 can be more easily limited in longitudinal vibration and vertical vibration driving the buffer connecting arm 4 and the supporting arm 5 to swing. Thus, the vibration buffering effect is ensured. In combination with FIG. 4, the supporting arm 5 includes two rod bodies 51 arranged transversely and two connecting plates 52 spaced transversely. The two connecting plates 52 and the two rod bodies 51 define a frame shape, and the two rod bodies 51 match the fixed arm 2 and the buffer connecting arm 4 in a hinged manner respectively. An end portion of the buffer connecting arm 4 is provided with a pipe body 43 arranged transversely, and the pipe body 43 sleeves a periphery of the rod body 51. The rod body 51 located above in FIG. 4 is tubular, and the rod body 51 located above sleeves the transverse rod 2b of the fixed arm 2; and the rod body 51 located below in FIG. 4 is rod-shaped, and the pipe body 42 sleeves the rod body 51 located below. The tubular rod body 51 is one end of the supporting arm 5 hinged to the fixed arm 2, and the rod-shaped rod body 51 is one end of the supporting arm 5 hinged to the buffer connecting arm 4. The pipe body 43 is one end of the buffer connecting arm 4 hinged to the supporting arm 5.

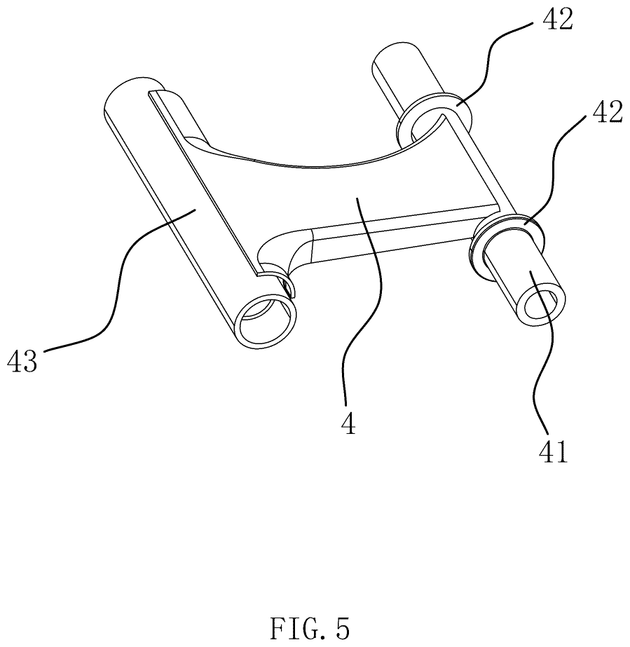

In combination with FIG. 2 and FIG. 4, damping bushings 7 arranged transversely and capable of increasing a relative swing resistance of the buffer connecting arm 4 and the supporting arm 5 are arranged at the hinge between the buffer connecting arm 4 and the supporting arm 5, and the damping bushings 7 are arranged between the rod body 51 and the pipe body 42. In combination with FIG. 6, damping bushings 7 arranged transversely and capable of increasing a swing resistance of the supporting arm 5 relative to the fixed arm 2 are arranged between the supporting arm 5 and the fixed arm 2, and the damping bushings 7 are located between the rod body 51 and the transverse rod 7c. Thus, the damping bushings 7 can strengthen the vibration buffering effect by consuming vibration energy of the engine 1 under the condition that a vibration direction of the engine 1 is constrained. In combination with FIG. 5, an end portion of the buffer connecting arm 4 is provided with a pipe sleeve 41 sleeving a periphery of the connecting rod 6, and the engine 1 is hinged to the pipe sleeve 41. The pipe sleeve 41 is one end of the buffer connecting arm 4 hinged to the connecting rod 6. Thus, the load borne at the portion can be shared by the pipe sleeve 41 sleeving the periphery of the connecting rod 6 bearing the load in a concentrated manner, so as to form protection for the connecting rod 6. Thus, centralized scraping on the connecting rod 6 is avoided, and the structural stability is improved. The engine 1 is provided with at least two connecting legs 11 spaced transversely, a peripheral surface of the pipe sleeve 41 is provided with two limiting stop shoulders 42, the two limiting stop shoulders 42 are located between the two connecting legs 11, and the two limiting stop shoulders 42 abut against the two connecting legs 11 in a limiting manner respectively. The two connecting legs 11 are both located between the two arm bodies 2a of the fixed arm 2, and the two connecting legs 11 sleeve two ends of the pipe sleeve 41 respectively; and the connecting rod 6 is arranged in the pipe sleeve 41 in a penetrating manner, and two ends of the connecting rod 6 extend out of the pipe sleeve 41 respectively and are inserted into the corresponding buffer rubber wheels 3 for fixation. As shown in FIG. 5, the buffer connecting arm 4 further includes a main body located between the pipe sleeve 41 and the pipe body 43. One side of the main body is a plane, and the other side of the main body is a concave cambered surface. Thus, the structural strength of the buffer connecting arm 4 can be improved, such that the mount connecting structure works stably.

The particular embodiments described herein are merely illustrative of the spirit of the disclosure. Those skilled in the technical field to which the disclosure belongs can make various modifications or additions to the described particular embodiments, or substitute them with a similar method, without departing from the spirit of the disclosure or being out of the scope as defined by the appended claims.

1. A mount connecting structure for a motorcycle engine, comprising: a fixed arm located on a frame and a buffer rubber wheel, wherein the mount connecting structure further comprises a buffer connecting arm, a supporting arm and a connecting rod, wherein the buffer rubber wheel sleeves a periphery of the connecting rod and is embedded in an end portion of the fixed arm, the engine is connected to the connecting rod, a first end of the buffer connecting arm is hinged to the connecting rod the connecting rod is arranged transversely, a first end of the supporting arm is hinged to the fixed arm, a second end of the buffer connecting arm is hinged to a second end of the supporting arm, and the supporting arm is obliquely arranged downwards to form an included angle relative to the buffer connecting arm

2. The mount connecting structure for a motorcycle engine according to claim 1, wherein two buffer rubber wheels are provided and are symmetrically arranged on two transverse sides of the engine.

3. The mount connecting structure for a motorcycle engine according to claim 1, wherein the buffer connecting arm has a length dimension greater than a length dimension of the supporting arm.

4. The mount connecting structure for a motorcycle engine according to claim 1, wherein a first damping bushing arranged transversely and capable of increasing a relative swing resistance of the buffer connecting arm and the supporting arm is arranged between the buffer connecting and the supporting arm, and a second damping bushing arranged transversely and capable of increasing a swing resistance of the supporting arm relative to the fixed arm is arranged between the supporting arm and the fixed arm.

5. The mount connecting structure for a motorcycle engine according to claim 2, wherein the two buffer rubber wheels are arranged at two transverse ends of the connecting rod respectively.

6. The mount connecting structure for a motorcycle engine according to claim 4, wherein the supporting arm comprises two rod bodies arranged transversely and two connecting plates spaced transversely, wherein the two connecting plates and the two rod bodies define a frame shape, and the two rod bodies match the fixed arm and the buffer connecting arm in a hinged manner respectively.

7. The mount connecting structure for a motorcycle engine according to claim 6, wherein the second end of the buffer connecting arm is provided with a pipe body arranged transversely, the pipe body sleeves a periphery of one of the two rod bodies, and the first damping bushing is arranged between the one of the two rod bodies and the pipe body.

8. The mount connecting structure for a motorcycle engine according to claim 1, wherein the first end of the buffer connecting arm is provided with a pipe sleeve sleeving a periphery of the connecting rod, and the engine is hinged to the pipe sleeve.

9. The mount connecting structure for a motorcycle engine according to claim 8, wherein the engine is provided with at least two connecting legs spaced transversely, a peripheral surface of the pipe sleeve is provided with two limiting stop shoulders, the two limiting stop shoulders are located between the two connecting legs, and the two limiting stop shoulders abut against the two connecting legs in a limiting manner respectively.

10. The mount connecting structure for a motorcycle engine according to claim 1, wherein the included angle between the buffer connecting arm and the supporting arm ranges from 70 degrees to 110 degrees.
